(19) United States
(12) Patent Application Publication
(10) Pub. No.: US 2009/0082229 A1
(43) Pub. Date: Mar. 26, 2009

(54) Process for Drying Boron-Containing Minerals and Products Thereof

(75) Inventors: James W. Dobson, JR., Houston, TX (US); Shauna L. Hayden, Houston, TX (US); Asheley D. Bowles, Houston, TX (US)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: Texas United Chemical Company, LLC, Houston, TX (US)

(21) Appl. No.: 12/237,105

(22) Filed: Sep. 24, 2008

Related U.S. Application Data
(60) Provisional application No. 60/974,687, filed on Sep. 24, 2007.
(60) Provisional application No. 61/036,625, filed on Mar. 14, 2008.

(51) Int. Cl. C09K 8/68; C01B 35/12

(52) U.S. Cl. 507/211; 423/279; 423/277

(57) ABSTRACT

Processes for the rapid and efficient drying of boron-containing compounds, in particular boron-containing minerals and ores, are described, as well as the products which result from such processes. The process comprises the steps of providing a boron-containing material; introducing the boron-containing material into a pre-heated furnace; heating the boron-containing material in the furnace at a temperature between about 800° F. and 1000° F.; retaining the boron-containing material within the furnace for a time ranging from about 5 minutes to about 120 minutes; and removing the boron-containing material from the furnace and allowing it to cool to ambient temperature. Optionally, the process may also comprise one or more steps of grinding and/or sizing the boron-containing material to a specific particle size prior to the introduction of the material to a furnace. The boron-containing compounds that can be processed in this manner include both naturally-occurring and/or synthetic boron-containing materials, in particular boron-containing minerals and ores such as colemanite, ulexite, probertite, kernite, and mixtures thereof.

### CROSS REFERENCE TO RELATED APPLICATIONS

The present application claims priority to U.S. Provisional Patent Application Ser. No. 60/974,687, filed Sept. 24, 2007, and U.S. Provisional Patent Application Ser. No. 61/036,625, filed Mar. 14, 2008, the contents of all of which are incorporated herein by reference

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to the rapid and efficient drying of boron-containing materials and the resultant products, and more specifically relate to processes for the rapid drying of boron-containing minerals and ores at temperatures at or above 800° F., and the products generated by such processes.

2. Description of the Related Art

Although representing only a small percentage, about 3 ppm, of the earth's crust, a wide range of boron-containing minerals are known. However, of the over 150 boron minerals having been identified, only a select few of these appear in concentrations that are commercially viable, which are fortunately concentrated in a limited number of localities in the world (e.g., Qinghai—Tibetan plateau, P. R. China; Inder lake in Turkmenistan; the north of Chile in the altiplano region; the Kramer District in the California desert, and Western Turkey, particularly the Bursa, Bigadic/Balikesir, Kütahya, and Eskisehir Provinces). Of those identified to date, the boron minerals of greatest commercial importance are often considered to be borax (Na₂B₄O₇-10H₂O), colemanite (Ca₂B₆O₁₁-5H₂O), ulexite (NaCaB₅O₉-8H₂O), hydroboracite (CaMgB₆O₁₁-6H₂O) and kernite (Na₂B₄O₇-4H₂O).

The utility of more commercially-available boron-containing minerals is well known, and both the sodium and calcium borates in particular have found many industrial applications. For example, they are used as a source of boron in fiberglass manufacture when the desired glass composition requires that sodium addition be limited, such as the case for textile fiberglass. They are also useful as fire retardant agents in such materials as plastics and rubber polymers, cellulosics, resins and oils, insulators, fiberglass, and the like, as well as in the manufacture of steel and ceramics and in the hydrocarbon recovery fields [see, Harben, P. W. and Dickson, E. M., in J. M. Barker and S. J. Lefonds (eds), “Borates: Economic Geology and Production”, SME Publications, New York, N.Y.; p. 4 (1985)]. However, a majority of boron minerals are found in their hydrated form, and are required to be dehydrated during their preparation before further processing and applications can be undertaken.

The dehydration of hydrated boron minerals is therefore important in the production of boron-containing compounds. Consequently, the dehydration and thermochemistry of such minerals, especially colemanite and ulexite, has been investigated generally using a variety of thermogravimetric methods, such as thermogravimetry (TG), differential thermal analysis (DTA), infrared (IR) analysis, differential thermogravimetry (DTG) analyses [see, for example, Celik, M. S., et al., Thermochimica Acta, Vol. 245, pp. 167-174 (1995); and, Ruoyu, C., et al., Thermochimica Acta, Vol. 306, pp. 1-5 (1997)].

Processes for the dehydration of minerals have to date typically been of two types—a first, slower mode of a calcination/dehydration process, and a second process that is termed “flash” (rapid) calcination/dehydration. In the traditional, slower calcination processes, the heating rate is slow, on the order of 1-10° C. min⁻¹, and the residence time of the material subjected to the process is long, on the order of several hours. One reported exemplary process describes the dehydration of pandermite, colemanite, and hawlite in the temperature range of 150-550° C., over a period of 5+ hours. Conversely, in the flash methods, the material is typically subjected to calcination/dehydration temperature of about 500° C. for a very short period of time, and the product is taken from the system very quickly. In this method, the heating rate is in the range of 10³-10⁵° C. sec.⁻¹, and the residence time of the solids within the calcination chamber is in the order of milliseconds to seconds [Bridson, D., et al., Clays Clay Miner., Vol. 33(3), pp. 258 (1985)]. The flash calcination/dehydration method has the advantage of providing important and useful physical and chemical changes to the minerals, which can in turn facilitate subsequent processes. However, this method requires specialized, expensive equipment, and is not readily adaptable to large-scale (e.g., 200 lbs+)dehydration processes.

More recently, an analysis of the dehydration of ulexite by microwave heating has been described using a laboratory type microwave reactor with a frequency of 2450 MHz [Eymir, C., et al., Thermochimica Acta, Vol. 428, pp. 125-129 (2005)]. However, this method required dehydration times ranging in excess of 30 minutes, depending upon the power of the microwave used, and appeared to require small particle sizes and constant microwave power of 300 W in order to obtain optimal results. Further, the use of microwave technology is generally limited to laboratory preparations and is not readily amenable to large scale manufacturing and processing, and thus could not likely be used in the commercial production of dehydrated boron minerals.

In view of these current methods, and given the current demand for boron-containing minerals in selected commercial sectors, there is a growing need for a dehydration processing method for such minerals that is rapid, efficient, economical, and can be carried out on a production-scale basis.

The inventions disclosed and taught herein are directed to improved methods and processes for the dehydration and drying of boron-containing compounds, especially minerals and ores, and the products produced from such methods.

### BRIEF SUMMARY OF THE INVENTION

Processes for the rapid and efficient dehydration of boron-containing compounds are described herein, as well as the products resulting from such processes. In accordance with one embodiment of the present disclosure, a process for producing boron-containing compounds having increased boron content is described, wherein the process comprises the steps of providing a boron-containing material; introducing the boron-containing material into a pre-heated furnace; heating the boron-containing material in the furnace at a temperature between about 800° F. and 1000° F.; retaining the boron-containing material within the furnace for a time ranging from about 5 minutes to about 120 minutes; and removing the boron-containing material from the furnace and allowing it to cool to ambient temperature. In accordance with a further aspect of this embodiment, the boron-containing mineral may be subjected to grinding for particle size unification and/or size reduction prior to the introduction of the material to the furnace. Such a pre-grinding process step may advantageously result in a loss of associated water from the boron-containing materials during the course of the grinding, thereby improving the efficiency of the overall process. In further accordance with this embodiment, the boron-containing compounds are naturally-occurring or synthetic boron-containing materials, including but not limited to colemanite, ulexite, probertite, kernite, tunnelite, and mixtures thereof, or materials comprising one or more of these minerals.

In accordance with a further embodiment of the present disclosure, boron-containing products prepared in accordance with the process of the present invention are described, wherein the boron-containing product advantageously exhibits an increase in the amount of boron available for crosslinking guar mixtures in hydraulic fracturing fluids as described herein, the increased amount of boron ranging from about 20% to about 40%, and/or a decrease in crosslink time as the boron content is increased, as determined by the Vortex Closure Test, the decrease in crosslink time ranging from about 35% to about 95% based on a comparison of the crosslink time of the pre-dried product. In accordance with further aspects of the present disclosure, the increase in crosslink time may range from about 45% to about 90%, based on a comparison with the crosslink time of the product prior to undergoing the drying process described herein. In further accordance with this embodiment of the present disclosure, the boron-containing product includes colemanite, ulexite, probertite, kernite, tunnelite, and mixtures thereof, or materials comprising one or more of these minerals.

In accordance with further embodiments of the present disclosure, fluids for fracturing subterranean formations in the earth, including those having a wellbore extending from the surface to the formation, are described. Such fluids comprise, among other optional additives, an aqueous mixture of a hydrated galactomannan gum and a crosslinking agent comprising a boron-containing compound prepared in accordance with the processes described herein, wherein the boron-containing product exhibits an increase in the amount of boron available for crosslinking ranging from about 20% to about 40%, and/or a decrease in crosslink time as the boron content is increased, the decrease in crosslink time being determined by the Vortex Closure Test and ranging from about 35% to about 95% based on the crosslink time of the pre-dried product.

In yet another embodiment of the present disclosure, fluids for fracturing subterranean formations are described, wherein the fluid is prepared by a process comprising the steps of (a) providing an aqueous mixture of a hydrated galtomannan gum; (b) adding to the aqueous mixture a cross-linking agent for crosslinking the hydrated galactomannan gum at the environmental conditions of the subterranean formation, wherein the crosslinking agent comprises a solution comprising a boron-containing mineral, wherein the boron-containing mineral is dried in accordance with the processes described herein and therefore has a resultant increased amount of boron available for crosslinking ranging from about 20% to about 40% compared with the pre-dried boron-containing mineral, and/or exhibits a decrease in crosslink time as the boron content is increased, the decrease in crosslink time determined by the Vortex Closure Test that ranges from about 35% to about 95% based on the crosslink time of the pre-dried product; (c) pumping the aqueous mixture of the hydrated galactomannan gum and the cross-linking agent into the subterranean formation through a wellbore at fracturing pressures; and (d) crosslinking the hydrated galactomannan gum with borate ions released by the cross-linking agent at the conditions of the subterranean formation.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates a general flow chart of the process of the present disclosure.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Applicants have created processes which provide for the rapid and efficient drying of boron-containing compounds, such as boron-containing minerals and ores, such that the dried product exhibits an increase in available boron of greater than 10 wt. % (expressed as borate content), exhibits an enhanced crosslinking time, and which resists further moisture uptake following such drying process.

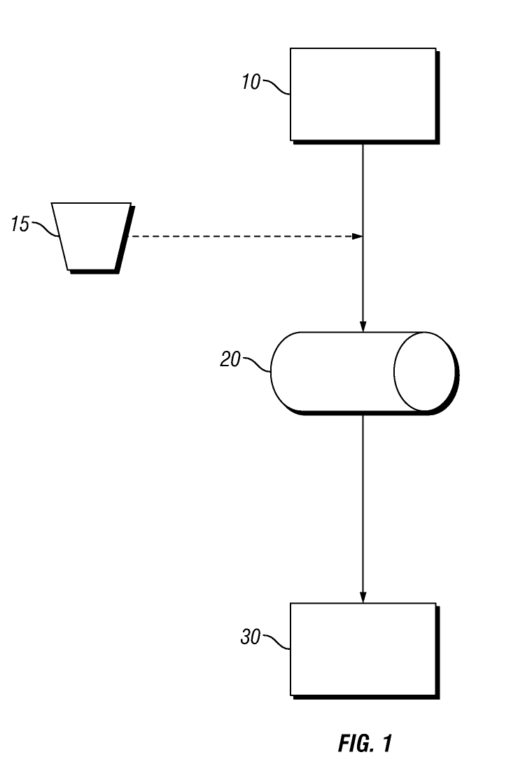

Turning now to the figures, the process of the present disclosure is generally illustrated in the flow diagram of FIG. 1. According to this process, at or near the start of the process, the boron-containing mineral(s) undergo a preliminary preparation step (10), the boron-containing mineral is obtained, and is prepared accordingly, which may include washing it, and/or floating it using known techniques in order to obtain a substantially uniform material (e.g., greater than 70% of the material is ulexite or colemanite). While the starting material is being processed in this initial stage, a furnace, such as a muffle furnace or the equivalent, is preheated to the target drying temperature, which may range from about 800° F. to about 1000° F., and the internal temperature within the furnace is allowed to equilibrate to the target drying temperature, ±5° F. At the next stage of the process (20), the boron-containing mineral or ore-sample is introduced into the furnace, and retained within the furnace for a period of time sufficient to dry the product to the desired specifications. Upon completion of the drying, sample is removed from the furnace and is allowed to cool to ambient temperature during the cooling stage (30), whereupon the dried and dehydrated boron-containing material product may be further processed as desired, or undergo analytical analysis or the equivalent, as appropriate. As also illustrated in FIG. 1, the drying process of the present disclosure may further include an optional step (15) of milling, crushing, or grinding the boron-containing material to a diminished particle size (e.g., on the order of from about 0.1 μm to about 200 μm) prior to the introduction of the material into the drying furnace at the drying stage (20). While not wishing to be bound by any theory, it is believed that reduced particle size of the boron-containing material may contribute advantageously to the rapid and effective drying/dehydration process of the present disclosure, due to the smaller particle sizes allowing for a more suitable environment for both evaporation and diffusion of water molecules to the surface of the material over a shorter period of time.

The particle size of the entering boron-containing compound feedstock in accordance with the processes of the present disclosure may vary considerably, depending on a number of factors, including the end use of the dried product. In general, the larger the particle size, the longer will be the residence time in the reaction zone of the furnace since, when the particles are larger, the heat may require a longer time to diffuse into the particles and accomplish the dehydration. Accordingly, and as indicated with relation to FIG. 1, the boron-containing compounds may optionally be milled and/or dried in milling/grinding step (15) in order to obtain a desired particle size distribution prior to their introduction to the drying furnace. The preferred particle size of the boron-containing minerals to be dried and processed in accordance with the present disclosure is between about 0.1 μm and 200 μm, including but not limited to about 0.25 μm, about 0.5 μm, about 1.0 μm, about 1.5 μm, about 5 μm, about 10 μm, about 35 μm, about 50 μm, about 65 μm, about 70 μm, about 75 μm, about 100 μm, about 110 μm, about 120 μm, about 130 μm, about 140 μm, about 145 μm, about 150 μm, about 155 μm, and about 160 μm, as well as values between any two of these values without limitation, such as particle size ranges between about 4 μm and about 10 μm, and about 8 μm, and ranges between any of these values, such as between about 0.5 μm to about 155 μm. The D10, D50, and D90 values represent the 10^{th} percentile, the 50^{th} percentile and the 90^{th} percentile of the particle size distribution (PSD), respectively, as measured by volume. That is, in example, the D10 a value on the particle size distribution curve such that 10% of the particles are less than and 90% are greater than the particle size at the applicable point of measurement. Similarly, the D50 and D90 values are those values on the particle size distribution curve such that 50% or 90%, respectively, of the particles are less than the particle size at the appropriate point of measurement. For example, for a particular sample, if D50=11 μm, there are 50% of the particles that are larger than 11 μm, and 50% of the particles that are smaller than 11 μm. The methods which may be used for determining the particle size distribution (PSD) of the boron-containing materials for use in accordance with the present disclosue include any of the standard methods for determining the particle size distributions of particulate materials in a particular size range (e.g., from 0.1 to 200 μm), including but not limited to gravitational liquid sedimentation methods as described in ISO 13317, and sieving/sedimentation methods such as described in ISO 11277, as well as by spectral, acoustic, and laser diffraction methods, as appropriate.

In a typical grinding/sizing process in accordance with this the milling/grinding step (15), the boron-containing ore is obtained from an appropriate source (e.g., a supplier in Turkey), and is typically pre-crushed and screened to an appropriate size, e.g., from about 5 to about 10 mesh. In accordance with particular aspects of the present disclosure, the received boron-containing ore material is then ground using an appropriate mill as discussed in more detail below, preferably an air classifier mill, in order to obtain a ground product having a primary particle size distribution ranging from about 0.1 μm to about 200 μm, preferably from about 0.25 μm to about 180 μm, and more preferably from about 0.5 μm to about 165 μm, with a D10, D50, and D90 of about 2, 11 and 43 microns, respectively. Of course, those of skill in the art will realize that particle size ranges which are more coarse or fine may also be utilized in accordance with the present disclosure, depending upon the specific end-product requirements (e.g., crosslinking characteristics) desired. Following the grinding of the boron-containing material, the appropriately sized particles are dried in an appropriate drying apparatus, such as a rotary dryer or the equivalent that has been brought to temperature. In a standard procedure in accordance with the presently disclosed processes, the fine, air-classified and sized powder is fed through a hopper and into an appropriate drying unit, wherein the feed rate into the drying unit is set by the retention time required in the dryer itself. Following completion of the drying process, the drying material is typically discharged into a holding bin, where it may then be taken to the next step in the process. Alternatively, and equally acceptable, the sized and dried boron-containing material may be transferred to lined containers, such as totes, for storage and later processing as appropriate.

In accordance with alternative aspects of the presently disclosed processes, the boron-containing material may be subjected to one or more dry grinding, or grinding-and-retaining steps prior to the process step of subjecting the boron-containing material to a drying apparatus. For example, and without limitation, the boron-containing material may be subjected to grinding in an appropriate grinding device as described herein, and subsequently transferred to a drying apparatus for continued processing and drying, retained within the grinding device for a period of time sufficient to drive off water from the material, or both. Alternatively, and equally acceptable, the boron-containing material may be ground within the grinding device and retained therein for a period of time, wherein the material may be optionally further heated using an appropriate heat-supply means so as to provide an initial drying process step to the material within the grinding device itself, which in some instances may negate the need to subject the material to further grinding. In this manner, water within the boron-containing minerals, including by-product water, water of hydration, and water associated with the mineral structure (including interlayer water, adsorbed water, and lattice water), may be advantageously removed as a result of the grinding operation (15). This exothermic removal of water from the boron-containing material from the dry grinding process (as well as for the other drying processes described herein) may be monitored using any number of known analytical methods, including but not limited to differential thermal analysis (DTA) of the ground material over a temperature and/or time range, X-ray diffraction methods, electron microscopy, and the like. In addition, such removal of water from the boron-containing material during the dry grinding process may advantageously act to reduce the residence time of the material within the drying furnace during the drying stage (20).

Numerous types of mills and solid material grinding devices are available in the processing industry for particle size reduction, any of which may be used in accordance with the present invention. Suitable mills suitable for use in accordance with the present disclosure include, but are not limited to, roller mills, wherein solids are crushed by multiple rollers and the particles are sized by screens; bond mills; ball mills, such as those having a rotating drum with internal rolling spheres and which utilize processing methods similar to those used with roller mills; fluid energy mills; cutter mills; hammer mills, wherein solids are typically crushed by rows of hammer plates against a liner, and particles are sized by screens; pin mills; vibration mills; jet mills, wherein solids are conveyed in a high velocity air stream against fracture plates, and the resultant particles are separated by a mill cyclone, allowing for very fine particle generation; and, air classifier mills (ACM), such as the Micro ACM 1 air classifier mills (available from Hosokawa Micron Corp., Osaka, Japan), wherein very fine particle sizes may be generated in high production volumes and with a high degree of accuracy, ACM's having classifiers associated with the milling apparatus for separating the fines from the course particles, and ACM's comprising classifying fluid inlets configured for feeding classifying fluid(s) such as air or other appropriate gases into an associated classifier. It will be realized by those of skill in the art that some mills will have advantages over others, depending upon the product and characteristics of the product to be resized, as well as the desired final particle size. For example, the fluid energy mill has some advantages over the ball mill, such as its higher milling efficiency [Dobson B, Rothwell E., “Particle size reduction in a fluid energy mill.” Powder Technol.; Vol. 3, pp. 213-217 (1969-70)] and its ability to mill thermolabile, hard, and abrasive compounds. In accordance with aspects of the present disclosure, the mill type which preferably may be used with the present processes is an air classifier mill (ACM), alone or in combination with any of the other mills described herein. In accordance with this aspect of the disclosure, it is envisioned that the boron-containing mineral or ore to be processed may be first fed into a hammer mill or the equivalent to obtain a coarse powder, and subsequently this powder may be further milled in an air classifier mill to reach the target average particle size. In accordance with one aspect of the present disclosure, the target particle sizes may be about 2 μm (for D10), about 11 μm (for D50), and about 43 μm (for D90).

Boron-containing compounds, as used herein, refers to solid boron-containing minerals and ores containing 5 wt. % or more boron, including both naturally-occurring and synthetic boron-containing minerals and ores. Exemplary naturally-occurring, boron-containing minerals and ores include but are not limited to boron oxide (B₂O₃), boric acid (H₃BO₃), borax (Na₂B₄O₇-10H₂O), colemanite (Ca₂B₆O₁₁-5H₂O), frolovite Ca₂B₄O₈-7H₂O, ginorite (Ca₂B₁₄O₂₃-8H₂O), gowerite (CaB₆O₁₀-5H₂O), howlite (Ca₄B₁₀O₂₃Si₂-5H₂O), hydroboracite (CaMgB₆O₁₁-6H₂O), inderborite (CaMgB₆O₁₁-11H₂O), inderite (Mg₂B₆O₁₁-15H₂O), inyoite (Ca₂B₆O₁₁-13H₂O), kaliborite (Heintzite) (KMg₂B_{O}₁₉-9H₂O), kernite (rasorite) (Na₂B₄O₇-4H₂O), kurnakovite (MgB₃O₃(OH)₅-15H₂O), meyerhofferite (Ca₂B₆O₁₁-7H₂O), nobleite (CaB₆O₁₀-4H₂O), pandermite (Ca₄B₁₀O₁₉-7H₂O), paternoite (MgB₂O₁₃-4H₂O), pinnoite (MgB₂O₄-3H₂O), priceite (Ca₄B₁₀O₁₉-7H₂O), preobrazhenskite (Mg₃B₁₀O₁₈-4.5H₂O), (probertite NaCaB₅O₉-5H₂O), tertschite (Ca₄B₁₀O₁₉-20H₂O), tincalconite (Na₂B₄O₇-5H₂O), tunellite (SrB₆O₁₀-4H₂O), ulexite (Na₂Ca₂B₁₀O₁₈-16H₂O),and veatchite Sr₄B₂₂O₃₇-7H₂O, as well as any of the Class V-26 Dana Classification borates, hydrated borates containing hydroxyl or halogen, as described and referenced in Gaines, R. V., et al. [Dana's New Mineralogy, John Wiley & Sons, Inc., 1997], or the class V/G, V/H, V/J or V/K borates according to the Strunz classification system [Hugo Strunz; Ernest Nickel: “Strunz Mineralogical Tables.” Ninth Edition. Stuttgart: Schweizerbart, (2001)]. Any of these may be hydrated and have variable amounts of water of hydration, including but not limited to trihydrates, tetrahydrades, hemihydrates, sesquihydrates, pentahydrates, decahydrates, and dodecahydrates. Further, in accordance with some non-limiting aspects of the present disclosure, it is preferred that the boron-containing compounds be borates containing at least 3 boron atoms per molecule, such as, triborates, tetraborates, pentaborates, hexaborates, heptaborates, decaborates, and the like.

In accordance with certain aspects of the present disclosure, the naturally-occurring boron-containing compounds may be represented by the general formula (I):

AMₐ AM′_{b} B_{c}O_{d}Siₘ—XH₂O (I)

wherein: AM is a Group I alkali metal selected from the group consisting of lithium (Li), sodium (Na), and potassium (K); AM′ is a Group I alkaline metal as described previously, or a Group II alkaline earth metal selected from the group consisting of magnesium (Mg), calcium (Ca), and strontium (Sr), with both the terms “Group I” and “Group II” referring to those element designations on the periodic table as described and referenced in “Advanced Inorganic Chemistry, 6^{th} Ed.” by F. A. Cotton, et al.[Wiley-Interscience, 1999]; B is the element boron; a is an integer selected from 0, 1, and 2; b an integer selected from 0, 1, 2, and 4; c is an integer selected from 0, 1, 2, 3, 4, 5, 6, 7, 8, 9, 10, 11, and 12, or multiples thereof, d is an integer selected from 1, 2, 3, 4, 5, 6, 7, 8, 9, 10, 11, and 12, or multiples thereof, m is an integer selected from 0, 1, or 2; and X is an integer selected from 0-40. Preferably, in accordance with this aspect of the disclosure, AM is Na, K, or Mg and AM′ is Ca, Mg, Na, or K, where a, b, c, d, and m are as defined above.

Synthetic boron-containing minerals which may be processed in accordance with the presently disclosed methods include, but are not limited to, nobleite and gowerite, all of which may be prepared according to known procedures. For example, the production of synthetic colemanite, inyoite, gowerite, and meyerhofferite is described in U.S. Pat. No. 3,332,738, assigned to the U.S. Navy Department, in which sodium borate or boric acid are reacted with compounds such as Ca(IO₃)₂, CaCl₂, Ca(C₂H₃O₂)₂ for a period of from 1 to 8 days. They synthesis of ulexite from borax and CaCl₂ has also been reported [Gulensoy, H., et al., Bull. Miner. Res. Explor. Inst. Turk., Vol. 86, pp. 75-78 (1976)]. Similarly, synthetic nobleite can be produced by the hydrothermal treatment of meyerhofferite (2CaO₃B₂O₃-7H₂O) in boric acid solution for 8 days at 85° C., as reported in U.S. Pat. No. 3,337,292. Nobleite may also be prepared in accordance with the processes of Erd, McAllister and Vlisidis [American Mineralogist, 46, 560-571 (1961)], reporting the laboratory synthesis of nobleite by stirring CaO and boric acid in water for 30 hours at 48° C., followed by holding the product at 68° C. for 10 days. Other techniques which may be used to generate synthetic boron-containing materials suitable for use in the process of the present disclosure include hydrothermal techniques, such as described by Yu, Z.-T., et al. [J. Chem. Soc., Dalton Transaction, pp. 2031-2035 (2002)], as well as sol-gel techniques [see, for example, Komatsu, R., et al., J. Jpn. Assoc. Cryst. Growth., Vol. 15, pp. 12-18 (1988)] and fusion techniques. However, while, synthetic boron-containing minerals may be used in the processes described herein, for use in preparing dried products suitable for use as crosslinking agents with guar or similar compositions in hydrocarbon production fluids (e.g. fracturing fluids) and operations, naturally-occurring boron-containing materials are preferred. This is due, in part, to the fact that although the synthetic compositions have the potential of being of higher purity than the naturally-occurring materials since they lack the mineral impurities found in naturally occurring specimens, they are generally relatively low in borate content by comparison.

Most preferably, in accordance with the present disclosure, the boron-containing compounds suitable for use with the disclosed process, and the products resultant from such processes, are selected from the group consisting of colemanite, ulexite, probertite, kernite, and mixtures thereof.

The furnace for use in heat-drying the boron-containing compounds during the drying stage (20), in accordance with the process of the present disclosure, includes any of a number of suitable commercial and customized furnaces that are designed for either the continuous or batch processing of granular, powder, or particulate aggregates under controlled temperature environments. While the furnace for use with the instant process may utilize either direct or indirect heating, it is preferred that the furnace utilize indirect heating. Exemplary furnaces for use with the present invention include but are not limited to rotary tube furnaces (such as those available from JND Technologies, Nottinghamshire, UK), tunnel furnaces, and indirect rotary furnaces (such as those available from Harper International Corp., Lancaster, N.Y.), high-temperature split tube and solid tube furnaces (such as available from Thermcraft, Inc., Winston-Salem, N.C.), continuous hot air heat treatment furnaces, such as those available from Kleenair Products (Portland, Oreg.), radiant-tube furnaces, muffle furnaces, and modifications thereof In general, any furnace which is capable of providing both the appropriate residence time and temperature requirements for the presently disclosed process may be used.

In accordance with certain aspects of the present disclosure, the boron-containing material within the furnace may optionally be contacted with a gas mixture comprising carbon dioxide, oxygen, nitrogen, or a combination thereof, in order to more effectively drive off the water during the heating and dehydration process.

The residence time of the boron-containing compounds within the furnace can range from about 5 minutes to about 120 minutes, and more preferably ranges from about 5 minutes to about 60 minutes. Exemplary residence times for the instant process include, but are not limited to, about 5 minutes, about 6 minutes, about 7 minutes, about 8 minutes, about 9 minutes, about 10 minutes, about 11 minutes, about 12 minutes, about 13 minutes, about 14 minutes, about 15 minutes, about 16 minutes, about 17 minutes, about 18 minutes, about 19 minutes, about 20 minutes, about 25 minutes, about 30 minutes, about 35 minutes, about 40 minutes, about 45 minutes, about 50 minutes, about 55 minutes, and about 60 minutes, as well as residence times within any of these residence times, such as about 22 minutes, or about 37 minutes, without limitation. The residence time for the boron-containing compounds in the reaction zone is also dependent on the loading. Typically, the fill volume of the furnace is about 5% and the residence time in the heated section ranges from about 5 minutes to about 60 minutes. More preferably, the residence time of the boron-containing compounds within the furnace ranges from about 5 minutes to about 30 minutes, inclusive of times within this time range. The residence time may be controlled in a rotary tube furnace, for example, in a known manner by controlling the speed of rotation and the degree to which the tube is tilted from the horizontal.

The temperature to which the boron-containing compound is heated within the furnace during the disclosed process ranges from about 800° F. (426.7° C.) to about 1,000° F. (537.8° C.), ±5° F./° C. Exemplary temperatures to which the boron-containing compound(s) are heated within the furnace during the residency time include, but are not limited to, about 805° F., about 810° F., about 815° F., about 820° F., about 825° F., about 830° F., about 835° F., about 840° F., about 845° F., about 850° F., about 855° F., about 860° F., about 865° F., about 870° F., about 875° F., about 880° F., about 885° F., about 890° F., about 895° F., about 900° F., about 905° F., about 910° F., about 915° F., about 920° F., about 925° F., about 930° F., about 935° F., about 940° F., about 945° F., about 950° F., about 955° F., about 960° F., about 965° F., about 970° F., about 975° F., about 980° F., about 985° F., about 990° F., about 995° F., and about 998° F., as well as values falling within any two of these temperatures, such as temperatures between about 950° F. and about 990° F., ±5° F. Preferably, the temperature to which the boron-containing compound is heated within the furnace ranges from about 950° F. (510° C.) to about 990° F. (532.2° C.), and more preferably from between about 960° F. (515.5° C.) to about 980° F. (526.7° C.), ±5° F./° C.

The product boron-containing compounds, in particular the product boron-containing minerals and ores, which are resultant from the heat-drying process described herein above, have the advantageous characteristics that following their brief residency within a furnace at elevated temperature, they exhibit not only marked increases in the boron content that is available for crosslinking and other applications, but also exhibit a decrease in the crosslinking times and abilities of the product, as determined using known tests for measuring crosslinking times of such materials, including but not limited to the Vortex Closure Test, the Static-Top test, and combinations thereof For example, the product boron-containing ore heat-dried in accordance with the presently disclosed processes may advantageously exhibit (compared to ores not dried in this manner) the synergistic effect of both an increase in the amount of boron available within the ore for crosslinking (e.g., with a hydrated galactomannan gum such as guar or hydroxypropyl guar), and a simultaneous decrease in the crosslink time as the boron content is increased, as measured by an appropriate test. As described herein, the increase in the amount of available boron may range from about 20 to about 40%, while the crosslink time may simultaneously decrease in the range from about 35 to about 95%. Additionally, the products tested following heat drying using the process described herein exhibited a low tendency to re-absorb the water lost from the surrounding atmosphere, even in hot and humid environmental conditions.

The products produced by the processes described herein, with their advantageous physical and chemical characteristics as described above, have a wide variety of applications. In accordance with an aspect of the present disclosure, the resultant products prepared by the processes described herein may be used in formulating hydrocarbon-based suspensions for the crosslinking of hydratable, polymer-containing well servicing fluids, for use in hydrocarbon recovery operations. Exemplary applications include, but are not limited to, in the preparation of hydraulic fracturing fluids, gravel packing fluids, and water-recovery fluids for use in subterranean formations, such as those fluids and applications described in U.S. Pat. No. 7,018,956, incorporated herein in its entirety.

For example, it is well known in the hydrocarbon recovery and exploration fields that organic polyhydroxy compounds having hydroxyl groups positioned in the cis-form on adjacent carbon atoms or on carbon atoms in a 1,3-relationship can react with borates to form five or six member ring complexes. Generally, at alkaline pH values above about 8.0, these complexes can form didiol crosslinked complexes, as shown in the general scheme (I) below. This didiol formation may in turn lead to a reaction with dissociated borate ions in the presence of polymers having the required hydroxyl groups in a cis-relationship. The reaction is typically fully reversible upon changes in the solution pH. An aqueous solution of the polymer will typically gel in the presence of borate when the solution is made alkaline, and will liquefy again when the pH is lowered below about 8. If the dry powdered polymer is added to an alkaline borate solution, it will not hydrate and thicken until the pH is dropped below about 8. The critical pH at which gelation occurs is modified by the concentration of dissolved salts. The effect of the dissolved salts is to change the pH at which a sufficient quantity of dissociated borate ions exists in solution to cause gelation. The addition of an alkali metal base such as sodium hydroxide enhances the effect of condensed borates such as borax by converting the borax to the dissociated metaborate.

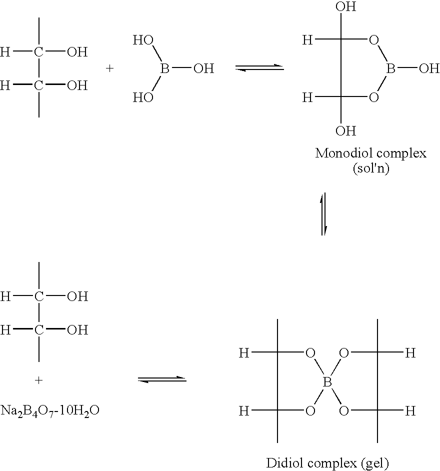

Known polymers which contain an appreciable content of cis-hydroxyl groups, and which are capable of being crosslinked by the boron-containing ores prepared in accordance with the present disclosure, are exemplified by guar gum, locust bean gum, dextrin, polyvinyl alcohol, and derivatives of these polymers, including but not limited to galactomannan gums such as guar and substituted guars such as hydroxypropyl guar (HPG) or carboxymethylhydroxypropyl guar, as well as cellulosic polymers such as hydroxyethyl cellulose (HEC) and synthetic polymers such as polyacrylamide. While derivatives of any of these guars and cellulose compounds may be used, it has typically be found that some derivatives tend to react less with borate ions as the amount of substituting groups in the molecule increases. This likely results from the shear molecular bulk of substituting groups changes the regular, alternating, and single-member branched, linear configuration of the molecule and prevents adjacent chains from approaching as closely as before (a steric hindrance effect), and the substitution of secondary cis-hydroxyl positions decreases the number of such unsubstituted positions available for complexing with the borate ion.

Strong reactions of such polymers are also obtained with solutions of certain inorganic cations. The addition of a high concentration of calcium salt, for example, will cause a polymer gel to form under alkaline conditions. If dry powdered polymer is added to the salt solution, the polymer will not generally hydrate and thicken. In general, the polymer will react with polyvalent cations much as it does with borate anions.

Depending on the relative concentration of polymer, and borate anion or polyvalent cation, the crosslinking reaction may produce useful gels, or may lead to insolubilization, precipitation, or unstable, non-useful gels. The viscosity of the hydrated polymer solution increases with an increase in the concentration of borate anion until a maximum is obtained. Thereafter the viscosity decreases and the gel becomes unstable as evidenced by a lumpy, inhomogeneous appearance and syneresis. As the temperature of the solution increases, the concentration of borate required to maintain the maximum degree of crosslinking, and thus maximum viscosity increases. Derivatization with non-ionic hydroxyalkyl groups greatly improves the compatibility of the polymer with most salts.

Hydraulic fracturing is a widely used method for stimulating petroleum producing subterranean formations and is commonly performed by contacting the formation with a viscous fracturing fluid having particulated solids, widely known as propping agents, suspended therein, applying sufficient pressure to the fracturing fluid to open a fracture in the subterranean formation, and maintaining this pressure while injecting the fracturing fluid into the fracture at a sufficient rate to extend the fracture into the formation. When the pressure is reduced, the propping agent within the fracture prevents the complete closure of the fracture.

The properties that a fracturing fluid should possess, are amongst others, low leakoff rate, the ability to carry a propping agent, low pumping friction loss, and it should be easy to remove from the formation. Low leakoff rate is the property that permits the fluid to physically open the fracture and one that controls its areal extent. The rate of leakoff to the formation is dependent upon the viscosity and the wall-building properties of the fluid. Viscosity and wall-building properties are controlled by the addition of appropriate additives to the fracturing fluid. The ability of the fluid to suspend the propping agent is controlled by additives. Essentially, this property of the fluid is dependent upon the viscosity and density of the fluid and upon its velocity. Friction reducing additives are added to fracturing fluids to reduce pumping loss due to friction by suppression of turbulence in the fluid. To achieve the maximum benefits from fracturing, the fracturing fluid must be removed from the formation. This is particularly true with very viscous fracturing fluids. Most of such viscous fluids have built-in breaker systems that reduce the viscous gels to low viscosity solutions upon exposure to the temperatures and pressures existing in the formations. When the viscosity is lowered, the fracturing fluid may be readily produced from the formation.

The use of aqueous based fluids to formulate fracturing fluids is generally known. Such fluids generally contain a water soluble polymer viscosifier. Sufficient polymer is used to suspend the propping agent, decrease the leakoff rate, and decrease the friction loss of the fracturing fluid. Supplemental additives are generally required to further decrease the leakoffrate, such as hydrocarbons or inert solids, such as silica flour.

Various water soluble polymers have been proposed for use as viscosifiers for aqueous based fracturing fluids, such as polyacrylamides, partially hydrolized polyacrylamides, and various polysaccharide polymers such as guar gum and derivatives thereof, and cellulose derivatives. However, guar gum and guar gum derivatives are the most widely used viscosifiers. Guar gum is suitable for thickening both fresh and salt water, including saturated sodium chloride brines. At least two basic types of guar gum formulations are used to obtain a desirable gelled water-base fluid. These are classified as materials suitable for batch mix operations and materials suitable for continuous mix operations. The most widely used form is the continuous mix grade which hydrates rapidly and reaches a useable viscosity level fast enough that it can be added continuously as the fluid is pumped down the well. This grade of guar gum has a very small particle size. The easy mixing or batch mix grades of guar gum are designed to take advantage of the complexing action of guar gum with borax. In the presence of borax or other boron-containing ores or materials, the guar gum can be dissolved in a slightly alkaline solution without increasing the viscosity of the solution. Thus, these easy mixing grades of guar are alkaline mixtures of guar gum and borax with a delayed-action acid. Methods of utilizing the crosslinking reaction of borates with guar gum in a continuous mix process has been described in the art before, such as that method disclosed in U.S. Pat. No. 3,974,077, which describes that the gelation time, or crosslinking time, is dependent upon the solubility rate of the delayed action basic compound and the time required to neutralize the acidic buffer.

In view of the above, and in accordance with the present disclosure, boron-containing products prepared in accordance with the drying processes of the present invention may be used in formulating fluids, such as fracturing fluids for use in hydraulic fracturing operations in association with subterranean formations, including those formations comprising at least one wellbore extending from the surface into the subterranean formation. Such fracturing fluids may comprise, among other optional additives, an aqueous mixture of a hydrated galactomannan gum and a crosslinking agent comprising a boron-containing compound or material prepared in accordance with the processes described herein, wherein the boron-containing product exhibits an increase in the amount of boron available for crosslinking ranging from about 20% to about 40%, and/or a decrease in crosslink time as the boron content is increased, the decrease in crosslink time being determined by the Vortex Closure Test (VCT) as expressed in a percentage and ranging from about 35% to about 95% based on the crosslink time of the pre-dried product, e.g., before the boron-containing material was subjected to the drying processes of the present disclosure.

In yet another embodiment of the present disclosure, fluids for fracturing subterranean formations may be prepared, and in particular delayed crosslinking fracturing fluid systems comprising borates dried in accordance with the instantly disclosed processes may be prepared, wherein the fluid or system is prepared by a process comprising the steps of (a) providing an aqueous mixture of one or more hydrated galactomannan gums or related compounds, such as guar or hydroxypropyl guar (HPG); and (b) adding to the aqueous mixture a cross-linking agent for crosslinking the hydrated galactomannan gum or related compound at the environmental conditions of the subterranean formation, wherein the crosslinking agent comprises a solution comprising a boron-containing mineral, wherein the boron-containing mineral is dried in accordance with the processes described herein and therefore has a resultant increased amount of boron available for crosslinking ranging from about 20% to about 40% more available boron compared with the pre-dried boron-containing mineral, and/or exhibits a decrease in crosslink time as the boron content is increased, the decrease in crosslink time determined by the Vortex Closure Test that ranges from about 35% to about 95% based on the crosslink time of the pre-dried product. Such a fracturing fluid or fluid system may further comprise process steps of pumping the aqueous mixture of the hydrated galactomannan gum or equivalent and the (boron-releasing) cross-linking agent into the subterranean formation through a wellbore at fracturing pressures, and then crosslinking the hydrated galactomannan gum or related compound with borate ions released by the cross-linking agent at the conditions of the subterranean formation. The fracturing fluids and fracturing fluid systems of the present disclosure may also further include one or more buffering agents, such as potassium carbonate, potassium hydroxide sodium hydroxide, or the like, which is effective to provide a pH for the fracturing fluid or fracturing fluid system in a range from about pH 8.0 to about pH 12.0, more preferably from about pH 9.5 to about pH 11.5, and more preferably from about pH 9.8 to about pH 11.0. The fracturing fluid or fluid system may also typically have incorporated therein a breaker for the gelled fluid which can be any of the type commonly employed in the art for borate crosslinked guar based fluids, including enzymatic breakers as well as soluble (e.g., oxidants such as ammonium persulfate or peroxide) and insoluble breakers. In addition, such fluids may can also contain other conventional additives common to the well service industry such as surfactants, corrosion inhibitors, and the like, as well as proppants. Propping agents are typically added to the base fluid prior to the addition of the crosslinking agent, although this is not necessary for purposes of the present disclosure. Propping agents suitable for use with fracturing fluids of the present disclosure include, but are not limited to, quartz sand grains, glass and ceramic beads, walnut shell fragments and other nut- or seed-based proppants, aluminum pellets, nylon pellets, and the like, any of which may be coated or non-coated. The propping agents are normally used in concentrations between about 1 to 8 pounds per gallon of fracturing fluid composition but higher or lower concentrations can be used as required.

Other commercial applications of the boron-containing materials which have been dried and dehydrated in accordance with processes of the present disclosure include but are not limited to the manufacture of second harmonic generation (SHG), electro-optical, and photo refractive devices, due to their second-order nonlinear optical (NLO) effects; as hosts of laser and luminescent materials; as thermoelectronic cathodal materials for microgenerators; as additives to cement and gypsum formulations; in the manufacture of glass and glass products, especially of E-glass, boron carbide (B₄C) and borides (for example, CaB₆, LaB₆, SiB₆, LiB₆, MgB₂, TiB₂, and TaB₂) which are used in ceramics applications; in the manufacture of fiber glass and glass wool; in metallurgical applications; in the production of ceramics; in pharmaceutical formulations; in bleaches and detergents; in the manufacture and formulation of paints, especially for the increase in durability and/or luster of paint compositions; in the preparation of wood treatments, especially as preservatives; as micronutrients, such as in the areas of plant nutrition; in the manufacture of fire/flame retardants; and as synergistic agents in polymeric and intumescent systems, such as described by Atikler, U., et al. [Polymer Degradation and Stability, Vol. 91(7), pp. 1563-1570 (2006)].

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Laboratory Drying of Boron-Containing Ores

Ulexite and colemanite samples used in the tests were obtained from the Bigadic region of Turkey. The boron-containing ores are typically received from the supplier having already been washed and crushed to about a 6-mesh particle size. Samples of the ores to be tested were ground to the desired particle size using a suitable grinding mill or sieve, such as an air classifier mill, so that the appropriate particle size distributions may be obtained, weighed to establish the initial weight prior to the drying procedure, and then dried using an indirect rotary drier. As shown in Table 1 below, the particle size distributions evaluated were at D-10, D-50, and D-90, and ranged from about 0.1 μm to about 98 μm for ulexite, and from about 0.68 μm to about 2,046 μm for colemanite.

TABLE 1
Particle size distribution (average) of ore samples pre-drying.

| Boron | D-10 | D-50 | D-90 |
|---|---|---|---|
| Compound | Pre-dry | Pre-dry | Pre-dry |
| Colemanite | 4.099 | 34.039 | 159.088 |
| Ulexite | 1.442 | 8.022 | 35.076 |

The ore samples were weighed prior to drying, to establish an initial weight, and were then placed in a platinum crucible, and inserted into a muffle furnace (Model No. FB1315M, 120V from Barnstead International, Dubuque, Iowa) that had been preheated to about 975° F. (about 524.3° C.), ±2° F., and equilibrated at that temperature for approximately 15 to 20 minutes. The internal temperature of the muffle furnace was allowed to return to the set point of about 975° F. (approximately 1-2 minutes), after which the sample was retained inside the furnace for a period of about 5 minutes, during which time the sample dried. The sample was then removed from the furnace, cooled in a dessicator, and then weighed. The samples were then analyzed for percent water loss, % boron content (pre- and post-drying), cross-linking time, particle size distribution, and moisture exposure analysis. The results of these studies are shown in Tables 2-3, below. As can be seen from the data in Table 2 pertaining to ulexite, the weight gain due to water re-absorption after a period of 10 days was only about 3.5 wt. %. Therefore, the net weight loss due to drying and subsequent exposure to the atmosphere (10 days) was about 25.4%, which for ulexite resulted in an increased available boron content of 15.56% compared to an undried sample having an available boron content of about 11.55%. Similarly, looking at the data in Table 3 which exhibits the post-dry exposure time effects for colemanite dried according to the present disclosure, the net weight loss due to drying/exposure over a period of 10 days (in Houston, Tex.) was about 18.58%, resulting in a boron content for the dried colemanite of about 15.47%, compared to an undried sample which had an available boron content of about 12.98%.

TABLE 2
Post-Dry Ulexite Exposure Time Effects.¹

| | | | | % Boron, |
|---|---|---|---|---|
| No. Days | Inside Temp. | Outside Temp. | % wt. | post |
| Exposed | (° F.) | (° F.) | Gain/Loss | drying |
| 0² | 72.4 | 82.0 | (−28.9%) | 15.85% |
| 1 | 75.0 | 82.0 | 2.41% | —³ |
| 2 | 75.0 | 82.0 | 0.23% | — |
| 3 | 72.0 | 83.0 | 0.16% | — |
| 4 | 72.0 | 84.0 | 0.09% | — |
| 7 | 73.4 | 80.0 | 0.40% | — |
| 8 | 72.3 | 83.0 | −0.03% | — |
| 9 | 70.0 | 79.0 | 0.19% | — |
| 10 | 69.1 | 78.0 | 0.05% | 15.56% |
| Cumulative H₂O | | | 3.5%⁴ | |
| uptake | | | | |

¹The sample weight was 1.00295 g; after drying the sample weight was 0.7131 g; the weight loss due to drying was 28.90%.
²Immediately after drying according to the process described herein.
³Not determined.
⁴The dried sample weight was 0.7131 g.; the cumulative weight gain over the period of 10 days was 3.5%.

TABLE 3
Post-Dry Colemanite Exposure Time Effects.¹

| | | | | % Boron, |
|---|---|---|---|---|
| No. Days | Inside Temp. | Outside Temp. | % wt. | post |
| Exposed | (° F.) | (° F.) | Gain/Loss | drying |
| 0² | 72.0 | 82.0 | (−20.23%) | 15.95% |
| 1 | 72.0 | 82.0 | 1.39% | —³ |
| 2 | 72.0 | 82.0 | 0.19% | — |
| 3 | 74.0 | 83.0 | 0.05% | — |
| 7 | 71.0 | 84.0 | 0.00% | — |
| 8 | 74.0 | 84.0 | 0.07% | — |
| 9 | 70.0 | 83.0 | −0.15% | — |
| 10 | 72.0 | 82.0 | 0.10% | 15.47% |
| Cumulative H₂O | | | 1.65%⁴ | |
| Uptake | | | | |

¹The sample weight was 1.002 g; after drying the sample weight was 0.79925 g; the weight loss due to drying was 20.23%.
²Immediately after drying according to the process described herein.
³Not determined.
⁴The dried sample weight was 0.79925 g.; the cumulative weight gain over the period of 10 days was 1.65%.

Several observations regarding the drying of boron-containing ores can be made, in light of the results obtained from utilization of the drying process described herein. With regard to ulexite, it appeared that the ore gradually lost water as the temperature increased, but in a reversible manner, until a temperature of about 400° F.-500° F. was reached, at which point the ulexite became stable, consistent with the observations of previous thermodynamic analyses of ulexite.

### Example 2

### Determination of Percent Boron Increase in Dried Ores

The procedure used to determine the boron content of both the raw and post-drying borate materials was a modified NaOH titration method. Generally, a 0.20 g sample of the material to be analyzed was weighed into a suitable container, the material was transferred to an Erlenmeyer flask, and 25 mL of dilute hydrochloric acid (HCl) was added to the flask containing the sample. The sample was allowed to dissolve, and the solution was then dissolved to a temperature just under boiling, after which the solution was cooled to room temperature in an ice-bath. Upon reaching room temperature, CaCO₃ (Ultracarb™ 12, available from TBC-Brinadd, Houston, Tex.) was added slowly to the solution to neutralize it, as indicated when the solution was no longer fizzing. The solution was again heated to just under boiling, cooled to room temperature, and filtered through Whatman no. 40 filter paper (or the equivalent). Methyl red indicator solution (1-3 drops) were added to the cooled solution, and the pH of the solution was adjusted to 5.4 with 0.05 N NaOH. Mannitol was added to the solution, and using a buret, the solution was titrated with 0.05 N NaOH until a pH of 6.8 was obtained. Based upon the amount of NaOH used to reach the endpoint, and both the boron and borate (B₂O₃) contents are calculated, based on the total molecular weight of a borate molecule. The values obtained for the test samples, which indicated the percent boron increase upon drying of the boron-containing minerals using the instant process, are summarized in Table 4.

TABLE 4
Percent Boron content increase in test sample, pre- and post-drying.

| | Pre-Dry | Post-Drying Boron % | | |
|---|---|---|---|---|
| Sample | Boron % | Initial | % Increase | % 10 days post-drying |
| Colemanite | 12.98 | 15.95 | 22.9 | 15.47 |
| Ulexite | 11.55 | 15.85 | 37.2 | 15.56 |

### Example 3

### Measurement of Cross-Linking in Boron-Containing Ores

The degree of cross-linking, pre- and post-drying, of several of the boron-containing ores was determined using standard methods, as described, for example, in U.S. Pat. No. 7,018,956. In general, to conduct the crosslinking tests, a 2% KCl-guar solution was prepared by dissolving 5 grams potassium chloride (KCl) in 250 ml distilled water or tap water, followed by adding 1.2 grams of fracturing fluid grade regular guar powder, such as WG-35, or the equivalent. The resulting mixture was agitated in a Waring blender for 30 to 60 minutes, to allow hydration of the guar polymer. Once the guar had completely hydrated, the pH of the guar solution was determined with a standard pH probe, and the initial temperature of the guar solution was also recorded. Typically, the initial guar mixture had a pH that was in the range from about 7.5 to about 8.0, and had an initial viscosity (as determined on a FANN® Model 35A viscometer, available from the Fann Instrument Company, Houston, Tex.) ranging from about 25 cp to about 30 cp at 77° F. 250 ml of the guar solution was placed in a clean, dry glass Waring blender jar. The mixing speed of the blender motor was adjusted using a rheostat (e.g., a Variac voltage controller) to form a vortex in the guar solution so that the acorn nut (the blender blade bolt) and a small area of the blade, that surrounds the acorn nut in the bottom of the blender jar was fully exposed, yet not so high as to entrain significant amounts of air in the guar solution. While maintaining mixing at this speed, 0.2500 g of the boron-containing ore to be tested was added to the guar solution to effect crosslinking. Upon addition of the entire boron-containing material sample to the guar solution, a timer was simultaneously started. The crosslinking rate is expressed by three different time recordings: vortex closure related time readings, T₁ and T₂, and hang lip time T₃. T₁ is defined herein as the time that has elapsed between the time that the crosslinker/boron-containing material is added and the time when the acorn nut in the blender jar just becomes fully covered by fluid. T₂ is defined as the time that has elapsed between the time that the crosslinker/boron-containing material is added and the time when the top surface of the fluid in the blender jar has just stopped rolling/moving and becomes substantially static. These two measurements are indicated in the tables herein as VC (for “vortex closure”) and ST (for “static top”), respectively. The blender mixing speed setting remained constant throughout this test (although the actual mixing speed may be reduced as the viscosity of the crosslinked fluid increases). Optionally, after T₂ was recorded, the mixing was stopped and the fluid was manually agitated back and forth between two beakers to observe the consistency of the cross-linked composition. This optional third measurement (T₃), referred to generally as the hang lip time, is defined herein as the time that has elapsed between the time that the crosslinker is added and the time when the crosslinked fluid forms a stiff lip that can hang on the edge of the blender's mixing jar. Those of ordinary skill in the art of evaluating fracturing fluids will quickly recognize the fundamental tenants of evaluating such fluids in the manner described in these Examples, although individual testing practices and procedures may vary from those described herein. The results of these tests are summarized in Table 5, below.

TABLE 5
Dried versus Un-dried crosslink test results.

| | Pre-Drying | | | Post-Drying³ | | | % Change in | |
|---|---|---|---|---|---|---|---|---|
| | | X-Linking | | | X-Linking | | Crosslinking | |
| Sample | Boron, wt. % | VC¹ | ST² | Boron, wt. % | VC | ST | VC | ST |
| Colemanite | 12.98 | 22:48 | 49:46 | 15.95 | 2:12 | 2:33 | 90.4% | 94.9% |
| Ulexite | 11.55 | 3:20 | 3:49 | 15.85 | 1:49 | 2:07 | 45.5% | 44.5% |

¹VC = vortex center test, measured as the elapsed time to close the vortex, in minutes and seconds.
²ST = static top test, measured as the elapsed time for the top of the fluid to become static, in minutes and seconds.
³Results for post-drying of the samples are reported as the average of three measurements of samples dried in accordance with Example 1.

Other and further embodiments utilizing one or more aspects of the inventions described above can be devised without departing from the spirit of Applicant's invention. Further, the various methods and embodiments of the disclosed process and resultant products can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims.

What is claimed is:

1. A process for producing boron-containing compounds having increased boron content, the process comprising:
providing a boron-containing material;
introducing the boron-containing material into a pre-heated furnace;
heating the boron-containing material in the furnace at a temperature between about 800° F. and 1000° F.;
retaining the boron-containing material within the furnace for a time ranging from about 5 minutes to about 120 minutes; and
removing the boron-containing material from the furnace and allowing it to cool to ambient temperature.

2. A process as set forth in claim 1, wherein the boron-containing material is a naturally-occurring boron-containing mineral.

3. A process as set forth in claim 2, wherein the naturally-occurring boron-containing mineral is selected from the group consisting of colemanite, ulexite, probertite, kernite, and mixtures thereof.

4. A process as set forth in claim 1, further comprising reducing the particle size of the boron-containing material to a specific particle size prior to introducing the boron-containing material to the furnace.

5. A process as set forth in claim 4, wherein the particle size of the boron-containing material is reduced to a specific particle size ranging from about 0.1 μm to about 200 μm prior to introduction to the furnace.

6. A process as set forth in claim 5, wherein the particle size of the boron-containing material is reduced to a specific particle size ranging from about 0.5 μm to about 160 μm prior to introduction to the furnace.

7. A process as set forth in claim 4, wherein the particle size of the boron-containing material is reduced using a mill selected from the group consisting of roller mills, ball mills, cutter mills, hammer mills, jet mills, vibration mills, and air classifier mills.

8. A process as set forth in claim 1, wherein the boron-containing material within the furnace is contacted with a gas mixture comprising carbon dioxide, oxygen, nitrogen, or a combination thereof.

9. A process as set forth in claim 1, wherein the heating operation is effected by introducing the boron-containing material into a furnace which is preheated to a heat-drying temperature and is concluded when the boron-containing material has reached a desired available boron content.

10. A process as set forth in claim 1, wherein the furnace is a rotary type furnace.

11. A process as set forth in claim 1, wherein the boron-containing material is heated in the furnace at a temperature ranging from about 950° F. to about 990° F., ±5° F.

12. A process as set forth in claim 11, wherein the boron-containing material is heated in the furnace at a temperature ranging from about 960° F. to about 980° F., ±5° F.

13. A process as set forth in claim 1, wherein drying of the boron-containing material in the furnace is effected over a period of time ranging from about 5 minutes to about 60 minutes.

14. A boron-containing product prepared in accordance with the process of claim 1, wherein the boron-containing product exhibits
(i) an increase in the amount of boron available for crosslinking ranging from about 20% to about 40%, and/or
(ii) a decrease in crosslink time as boron content is increased, as determined by the Vortex Closure Test that ranges from about 35% to about 95% based on the crosslink time of the pre-dried product.

15. The product of claim 14, wherein the resultant boron-containing product is ulexite.

16. The product of claim 14, wherein the resultant boron-containing product is colemanite.

17. The product of claim 14, wherein the resultant boron-containing product exhibits an increase in crosslink time ranging from about 45% to about 90%.

18. A fluid for fracturing a subterranean formation comprising:
(a) an aqueous mixture of a hydrated galactomannan gum, and
(b) a crosslinking agent comprising a boron-containing compound prepared in accordance with the process of claim 1, wherein the boron-containing product exhibits,
(i) an increase in the amount of boron available for crosslinking ranging from about 20% to about 40%, and/or
(ii) a decrease in crosslink time as the boron content is increased, the decrease in crosslink time determined by the Vortex Closure Test and ranging from about 35% to about 95% based on the crosslink time of the pre-dried product.

19. A fluid for fracturing a subterranean formation, wherein the fluid is prepared by a process comprising the steps of:
(a) providing an aqueous mixture of a hydrated galtomannan gum;
(b) adding to the aqueous mixture a cross-linking agent for crosslinking the hydrated galactomannan gum at the environmental conditions of the subterranean formation, wherein the crosslinking agent comprises a solution comprising a boron-containing mineral,
wherein the boron-containing mineral is prepared by the process of claim 1, has an increased amount of boron available for crosslinking ranging from about 20% to about 40% compared with the pre-dried boron-containing mineral, and/or
exhibits a decrease in crosslink time as the boron content is increased, the decrease in crosslink time determined by the Vortex Closure Test that ranges from about 35% to about 95% based on the crosslink time of the pre-dried product;
(c) pumping the aqueous mixture of the hydrated galactomannan gum and the cross-linking agent into the subterranean formation through a wellbore at fracturing pressures; and
(d) crosslinking the hydrated galactomannan gum with borate ions released by the cross-linking agent at the conditions of the subterranean formation.

20. A fracturing fluid as set forth in claim 19, wherein the hydrated galactomannan gum comprises guar.

21. The fracturing fluid as set forth in claim 19, wherein the hydrated galactomannan gum comprises hydroxypropyl guar.
